(19) United States
(12) Patent Application Publication
(10) Pub. No.: US 2022/0383370 A1
(43) Pub. Date: Dec. 1, 2022

(54) SYSTEM AND METHOD FOR VALIDATING COMMODITY TRANSACTIONS

(71) Applicant: NatureTrak, Inc., Vacaville, CA (US)

(72) Inventors: Sean Kammerich, Elk Grove, CA (US); Jontae James, Sacramento, CA (US); William R. Martindale, Vacaville, CA (US); Ronald Brandon Ockimey, Vacaville, CA (US)

(21) Appl. No.: 17/485,396

(22) Filed: Sep. 25, 2021

Related U.S. Application Data
(60) Provisional application No. 63/193,171, filed on May 26, 2021.

(51) Int. Cl. G06Q 30/06; G06Q 10/08; G06Q 30/00

(52) U.S. Cl. CPC G06Q 30/0607; G06Q 10/087; G06Q 30/018

(57) ABSTRACT

A system and method for validating commodity transactions are disclosed. A particular embodiment is configured for: establishing, by use of a data processor and a data network, a data connection with at least one operator platform; receiving a commodity transaction request from an operator at the at least one operator platform; aggregating third party information obtained from one or more third party network resources; determining an available level of collateral corresponding to the operator; determining if the commodity transaction request is validated based on the aggregated third party information and the available collateral level; and communicating with at least one depository platform to communicate whether the commodity transaction request and available collateral level are validated.

### PRIORITY PATENT APPLICATION

This non-provisional patent application draws priority from U.S. provisional patent application Ser. No. 63/193,171; filed May 26, 2021. This present non-provisional patent application draws priority from the referenced patent application. The entire disclosure of the referenced patent application is considered part of the disclosure of the present application and is hereby incorporated by reference herein in its entirety.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2020-2021 NatureTrak, Inc., All Rights Reserved.

### TECHNICAL FIELD

This patent application relates to computer-implemented software systems, according to one embodiment, and more specifically to a system and method for validating commodity transactions.

### BACKGROUND

In a conventional commodity transaction, a depository (e.g., a bank or credit union receiving product or commodity funds) would receive an email from an operator (e.g., a licensed product or commodity manufacturing, distribution, or sales entity) with an amount the operator would like to deposit along with supporting documentation. This documentation would typically be a sales invoice. The depository would manually review the documentation and look up the status of the operator's product license. If the license was in good standing and the paperwork aligned with the transaction, then the deposit was accepted.

The drawback of this conventional approach is that deposit amounts often do not align with invoices for a variety of reasons. Invoices also may not always be aligned with the government Track and Trace data. For example, the California Cannabis Track-and-Trace (CCTT) system is being used statewide to record the inventory and movement of cannabis and cannabis products through the commercial cannabis supply chain. This system must be used by all annual and provisional cannabis licensees, including those with licenses for cannabis cultivation, manufacturing, retail, distribution, testing labs, and microbusinesses. Conventional technology does not provide a way to efficiently validate compliance with these government track and trace requirements. Lastly, the status of the license at the time of the transaction is not always known. As a result, the financial risk controls using this conventional methodology are inadequate to prevent money laundering and other problems.

### SUMMARY

In various example embodiments described herein, a system and method for validating commodity transactions are disclosed. In the various example embodiments described herein, a computer-implemented tool or software application (app) as part of a commodity transaction validation system is described to automate and improve the analysis and verification of commodity transactions between parties in the transaction. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, consumer electronic devices, or any other type of computing, data processing, communication, networking, or electronic system. In various example embodiments described herein, a commodity transaction validation system is described. In general, the disclosed system and method provide a new and improved information aggregation technology that can be used to collect information from a variety of 3rd party sources, parse the collected information for relevant details, aggregate the relevant details, and use the details to validate or invalidate a commodity transaction between parties to the transaction. In a particular example embodiment, the disclosed system and method facilitate the deposit of product funds into financial institutions. The disclosed system and method validate compliance with state, FDIC, and NCUA product deposit guidelines. Particular embodiments can be used in the automated discovery of illicit operational activity of legitimate cannabis operators. The disclosed system and method can also balance product sales against the use of financial services in regulated environments. This detection works across multiple dimensions of analysis. Details of the various example embodiments disclosed herein are provided below and in the accompanying drawings.

### BRIEF DESCRIPTION OF THE DRAWINGS

The various embodiments are illustrated by way of example, and not by way of limitation, in the figures of the accompanying drawings in which:

FIG. 1 illustrates an operational workflow for Track and Trace Collateral Acceptance process used with the commodity transaction validation system of an example embodiment;

FIG. 2 illustrates an operational workflow for License Vetting used with the commodity transaction validation system of an example embodiment;

FIGS. 3 and 4 illustrate a user interface for an Operator Deposit Process used with the commodity transaction validation system of an example embodiment;

FIG. 5 illustrates a user interface for a Depository Acceptance Process used with the commodity transaction validation system of an example embodiment;

FIG. 6 illustrates an operational workflow for a transaction between an operator and a depository as validated by the commodity transaction validation system of an example embodiment;

FIGS. 7 and 8 illustrate a system architecture and a networked system in which various embodiments may operate;

FIG. 9 illustrates another example embodiment of a networked system in which the data retrieval module can interface and retrieve data from a variety of networked 3^{rd} party data sources;

FIG. 10 illustrates another example embodiment of a networked system in which various embodiments may operate;

FIG. 11 illustrates a processing flow diagram that illustrates an example embodiment of a method as described herein; and

FIG. 12 shows a diagrammatic representation of a machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In various example embodiments described herein, a system and method for validating commodity transactions are disclosed. In the various example embodiments described herein, a computer-implemented tool or software application (app) as part of a commodity transaction validation system is described to automate and improve the analysis and verification of transactions between parties in the transaction. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, consumer electronic devices, or any other type of computing, data processing, communication, networking, or electronic system.

In various example embodiments described herein, a commodity transaction validation system is described. Details of the various example embodiments are disclosed in more detail below.

### Glossary of Terms

Depository: Banks or credit unions receiving product funds.

Operator: Licensed product manufacturing, distribution, or sales entity.

Value Token: Cash, check, wire, ACH, digital currency, etc. Any monetary transmission method.

Track and Trace: The government controlled system that tracks products through the supply chain and is the system of record.

### Process Overview of an Example Embodiment

By accessing the government Track and Trace system, the commodity transaction validation system disclosed herein can download data corresponding to all state sanctioned transfers of product and sales information. This information is ingested into the commodity transaction validation system and is used as collateral for deposits.

Operators are then enabled to utilize the commodity transaction validation system's operator portal and input a deposit amount. That corresponding amount is subtracted from the collateral. The deposit request is then sent to the Depository portal for review.

The Depository then receives the deposit request and reviews the details of the Value Token. If the details conform to their internal controls, the deposit is accepted and the collateral is debited.

### Accounting Integration

The commodity transaction validation system of an example embodiment is able to connect to over 100 different legacy accounting software packages or applications. The commodity transaction validation system can be configured to track accounts payable from the cash “accounts” in the accounting software. When an Operator pays a vendor or service provider in cash, the amount is subtracted from the available collateral.

### Track and Trace Collateral Acceptance

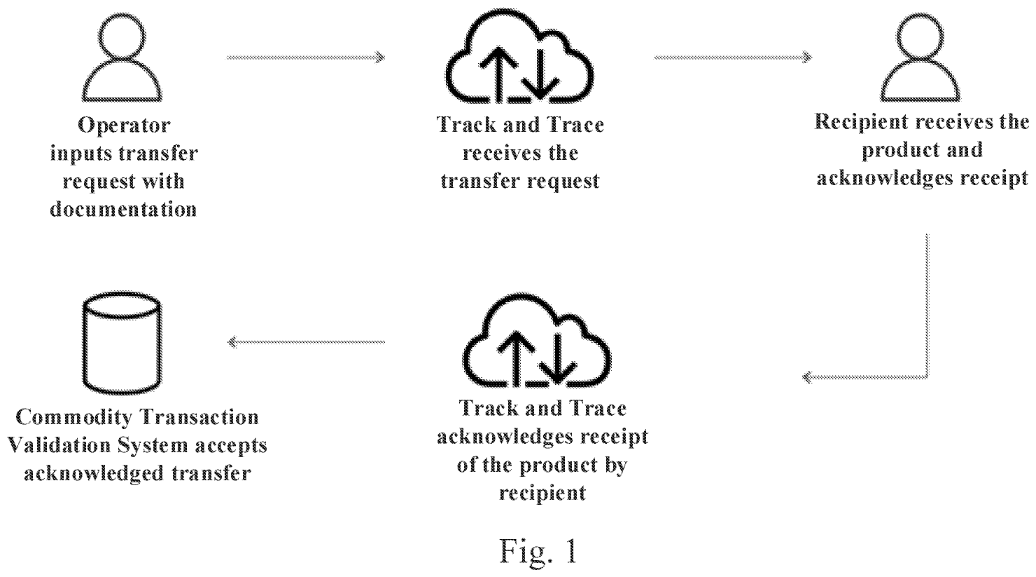

FIG. 1 illustrates an operational workflow for Track and Trace Collateral Acceptance process used with the commodity transaction validation system of an example embodiment. Track and Trace is a dual control system. The sender will create a product transfer request and send it to the recipient. The sender then ships the product to the recipient. After receipt, the recipient will log into the track and trace system and acknowledge the receipt of goods.

Once the recipient has acknowledged receipt, the commodity transaction validation system considers the transaction as sanctioned or validated and dual controlled. The commodity transaction validation system can then collect the product transfer requests and give collateral credit to deposit against the operator.

### License Vetting

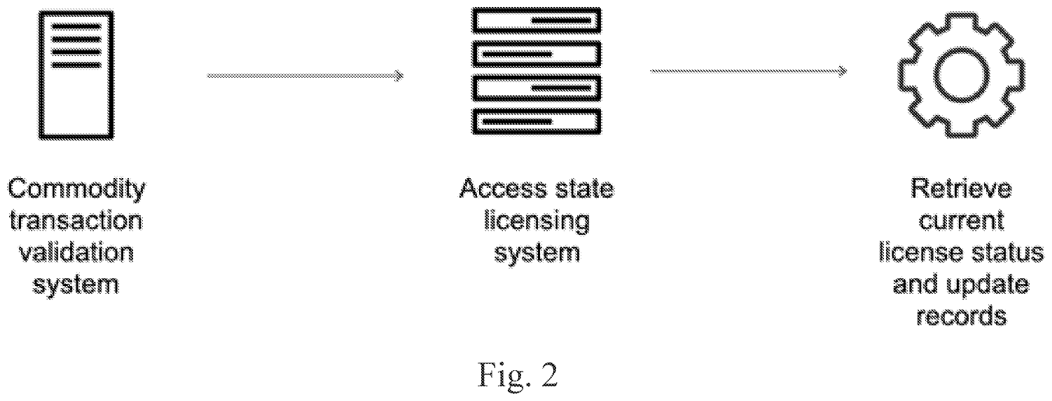

FIG. 2 illustrates an operational workflow for License Vetting used with the commodity transaction validation system of an example embodiment. Using the state product license registry, up-to-date information is kept on the Operator license status. If a transaction ever occurs during an unlicensed period, the transfer is rejected.

### Operator Deposit Process

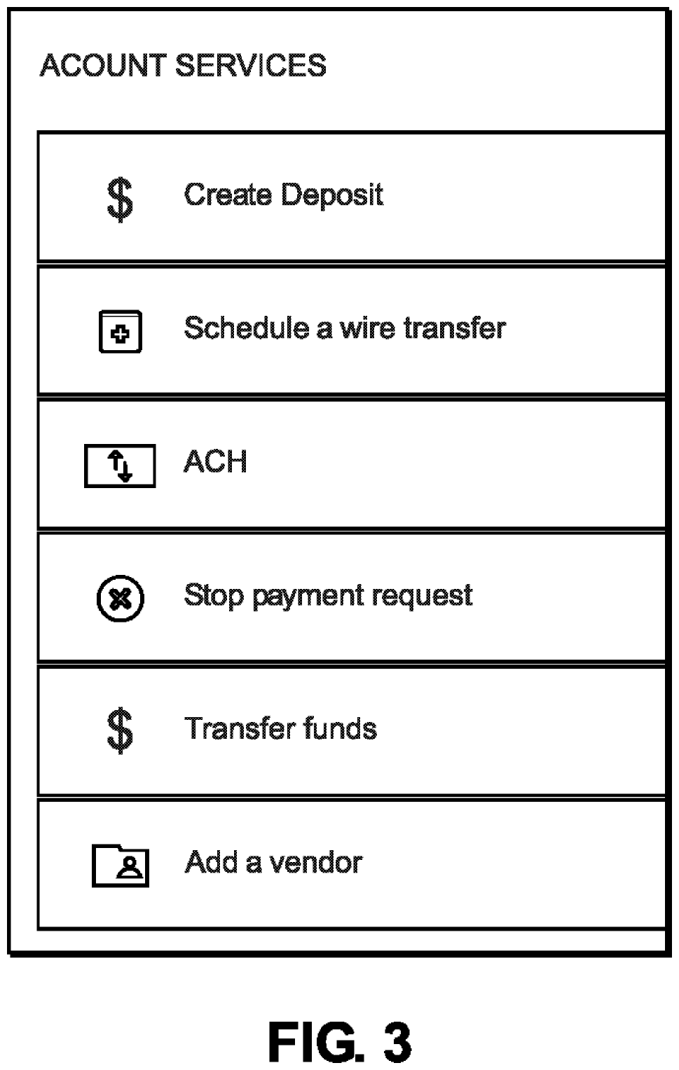

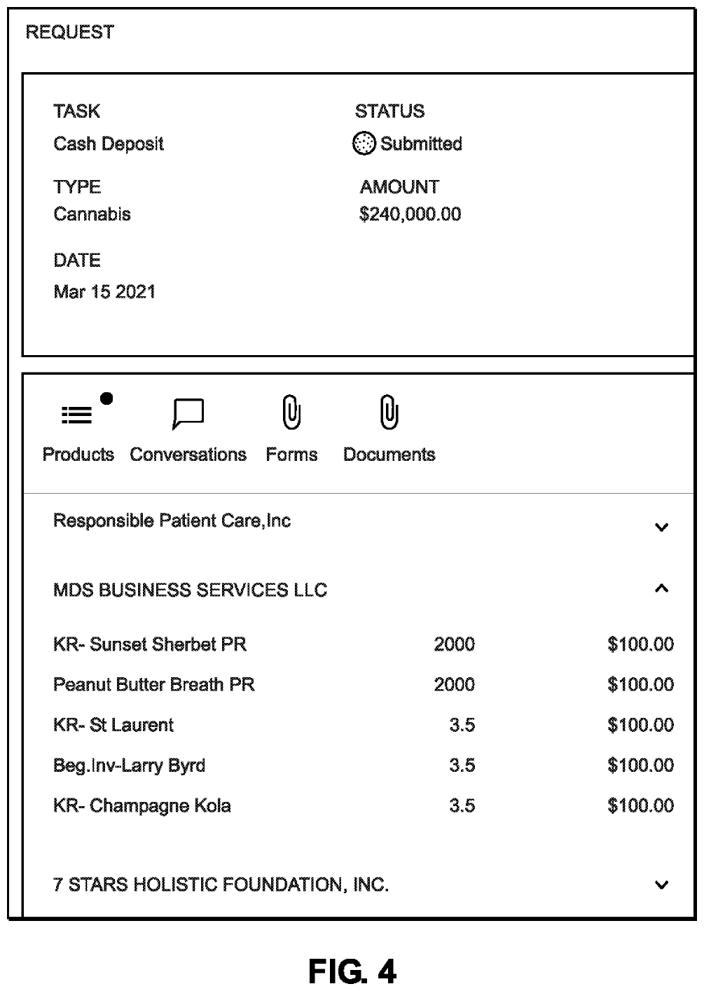

FIGS. 3 and 4 illustrate a user interface for an Operator Deposit Process used with the commodity transaction validation system of an example embodiment. Operators log into the commodity transaction validation system using an Operator portal as shown in FIGS. 3 and 4.

Referring to FIG. 3, the operator must first create a vendor to conduct transactions. This allows for OFAC (Office of Foreign Assets Control) sanction list checks along with reputation and other assessment methodologies. After the vendor is created, the operator can select a Value Token to deposit against. Once the deposit is created, the product collateral is provisionally allocated to the deposit as shown in FIG. 4.

Referring to FIG. 4, the product is allocated in partial or whole units to achieve a desired deposit amount. The request is then sent to the Depository.

### Depository Acceptance Process

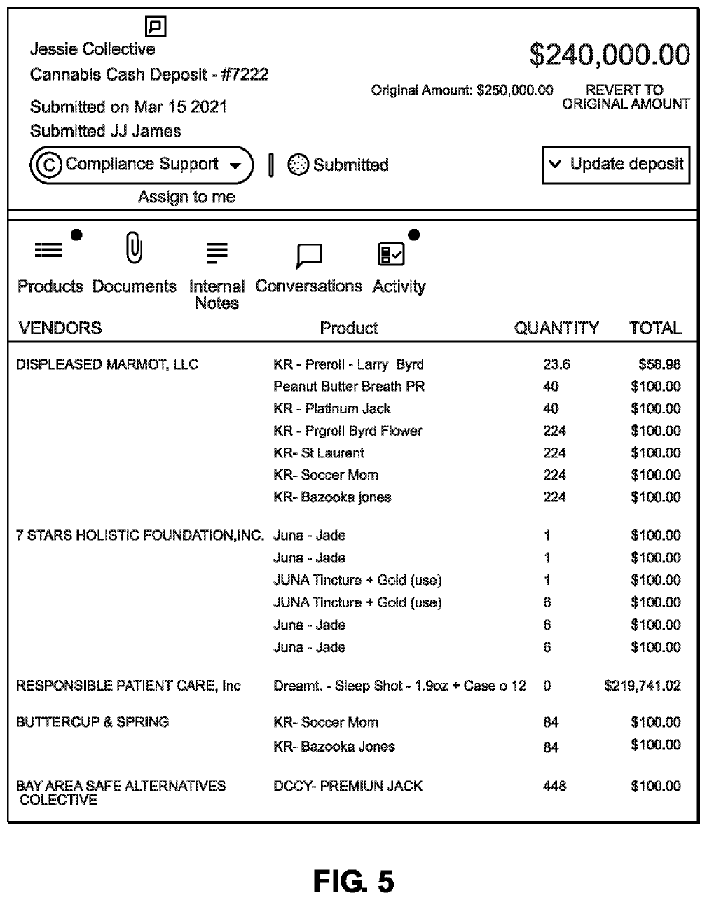

FIG. 5 illustrates a user interface for a Depository Acceptance Process used with the commodity transaction validation system of an example embodiment. The Depository receives the request and reviews the details as shown in the example of FIG. 5. Based on the token type, a decision is made to accept or reject the deposit request. At this point, all regulatory adherence validation has already occurred around the product portion of the transaction, and it can be handled as a normal transaction.

### Sample Process Flow

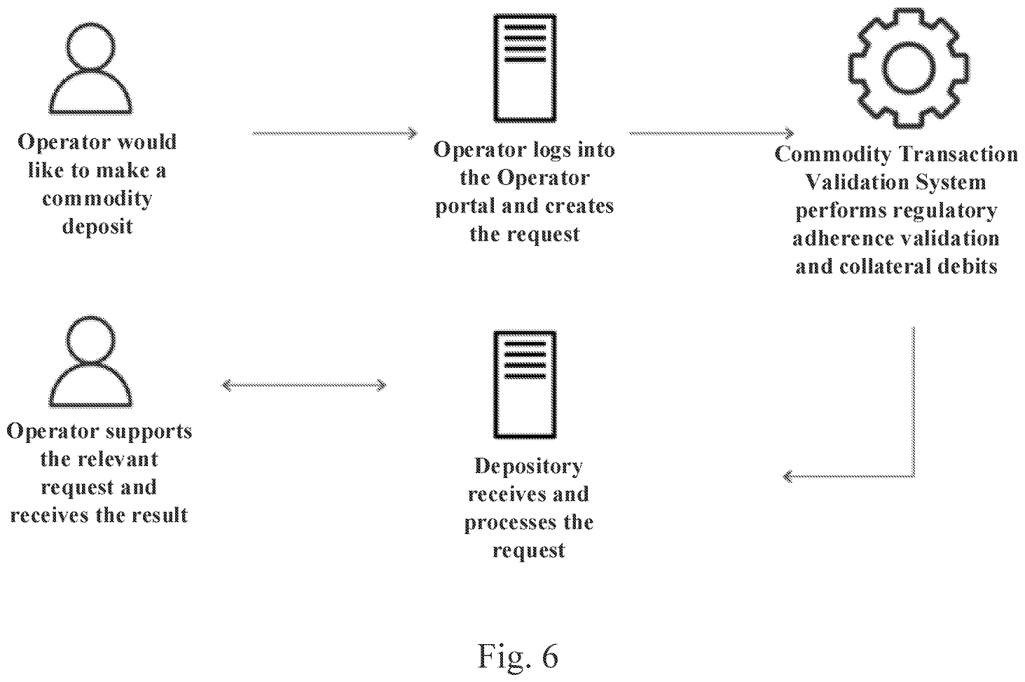

FIG. 6 illustrates an operational workflow for a transaction between an operator and a depository as validated by the commodity transaction validation system of an example embodiment. In a particular example, an Operator would like to perform a deposit of $50,000. The Operator can log into the Operator portal of the commodity transaction validation system and select the deposit type. The commodity transaction validation system informs the operator they have $63,000 in collateral available. The Operator can move forward with the transaction reducing their collateral to $13,000. The depository accepts the request for $50,000 and the transaction is completed.

By virtue of the improved processing and 3^{rd} party data retrieval and aggregation, the commodity transaction validation system of an example embodiment provides operators and depositories with a systematized and automated process that performs strict money laundering controls and regulatory adherence. The Depository employee vetting time is vastly reduced. The Track and Trace system is fully aligned with collateral for deposits.

### System Architecture

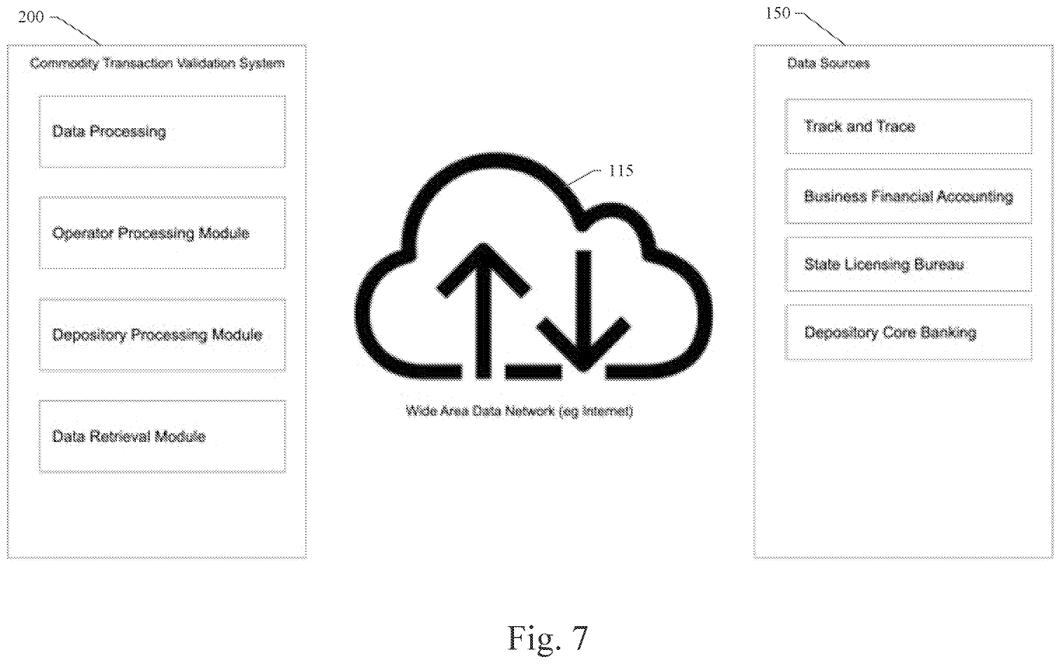

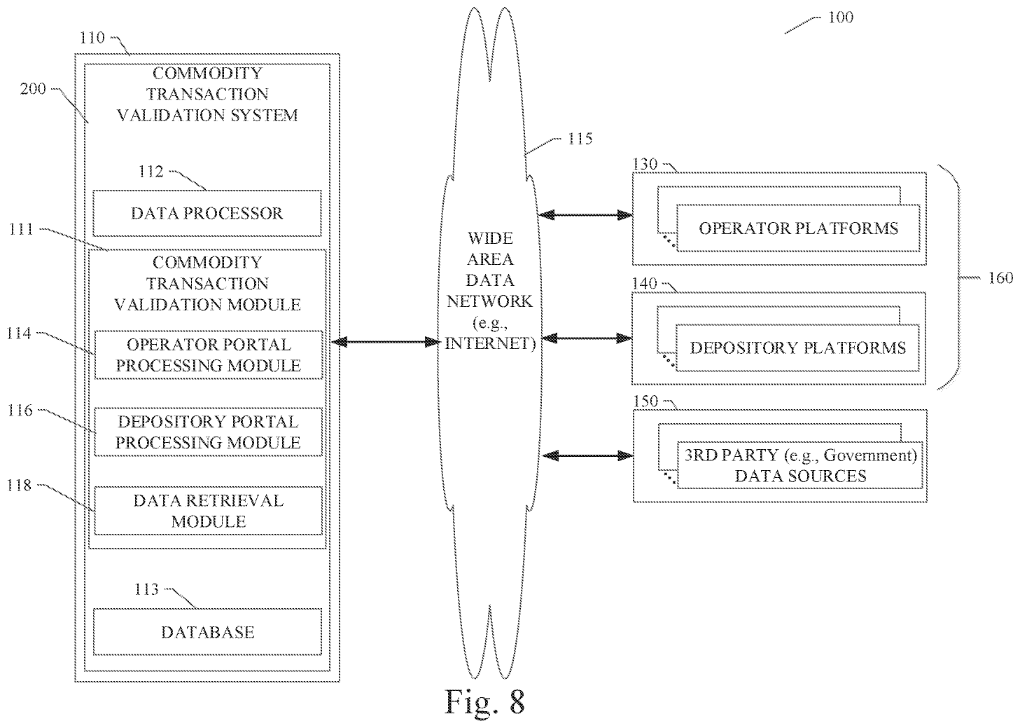

FIGS. 7 and 8 illustrate a system architecture and a networked system in which various embodiments may operate. In various example embodiments, an application or service, typically provided by or operating on a host site (e.g., a website) 110, is provided to simplify and facilitate the downloading or hosted use of the commodity transaction validation system 200 of an example embodiment. In a particular embodiment, the commodity transaction validation system 200 can be downloaded from the host site 110 by a user at a user platform 160. Alternatively, the commodity transaction validation system 200 can be hosted by the host site 110 for a networked user at a user platform 160. The details of the commodity transaction validation system 200 for an example embodiment are provided below.

Referring again to FIGS. 7 and 8, the commodity transaction validation system 200 can be in network communication with a plurality of 3rd party data sources 150, operator platforms 130, and depository platforms 140. The 3rd party data sources 150 can include online databases, websites, government sites, or other network resources at which information regarding product sales, deliveries, and transactions is available. The commodity transaction validation system 200 can be configured to facilitate data communications for the user platforms serving as networked platforms for operators and depositories to provide and obtain operator information, depository information, product information, transaction information, and the like in a digital or computer-readable form via the network 115. The operator platforms 130 can include user platform computing and/or communication devices configured to serve as networked platforms for licensed product manufacturing, distribution, or sales entities. The commodity transaction validation system 200 can also be in network data communication with a plurality of other 3^{rd} party information sites 150, such as government Track and Trace data or licensing platforms. These types of on-line commodity data or licensing sites and product information sites are well known to those of ordinary skill in the art.

The commodity transaction validation system 200 can also be in network data communication with a plurality of depository platforms 140. The commodity transaction validation system 200 be configured to provide data communications for the user platforms or websites serving as networked platforms for depositories being banks or credit unions receiving or providing product funds and to obtain operator or transaction information in a digital or computer-readable form from one or more of the operator platforms 130 or 3^{rd} party sources 150 via the network 115. The commodity transaction validation system 200 be also be configured to provide data communications with the 3^{rd} party data sources 150 to enable the networked usage, transfer, downloading, and aggregation of information from the 3^{rd} party data sources 150.

One or more of the 3rd party data sources 150 can be provided by one or more third party providers operating at various locations in a network ecosystem. It will be apparent to those of ordinary skill in the art that 3rd party data sources 150 can include or be any of a variety of networked third party information providers or on-line government information sites as described herein. In a particular embodiment, a resource list maintained at the host site 110 can be used as a summary or list of all 3rd party data sources 150, which users or the host site 110 may visit/access and from which users or the host site 110 can obtain operator information, depository information, or transaction information. The host site 110 (and the commodity transaction validation system 200 therein), 3rd party data sources 150, operator platforms 130, and depository platforms 140 may communicate and transfer data and information in the data network ecosystem shown in FIGS. 7 and 8 via a wide area data network (e.g., the Internet) 115.

Network 115 is configured to couple one computing device with another computing device. Network 115 may be enabled to employ any form of computer readable media for communicating information from one electronic device to another. Network 115 can include the Internet in addition to a local area network (LAN), wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth™, satellite, or modem and temporary telephone link.

Network 115 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Network 115 may also include an autonomous system of terminals, gateways, routers, and the like connected by wireless radio links or wireless transceivers. These connectors may be configured to move freely and randomly and organize themselves arbitrarily, such that the topology of network 115 may change rapidly and arbitrarily.

Network 115 may further employ a plurality of access technologies including 2nd (2G), 2.5, 3rd (3G), 4th (4G), 5th (5G) generation radio access for cellular systems, WLAN, Wireless Router (WR) mesh, and the like. Access technologies such as 2G, 3G, 4G, 5G, and future access networks may enable wide area coverage for mobile devices, such as one or more of client devices 141, with various degrees of mobility. For example, network 115 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Network 115 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, network 115 may include virtually any wired and/or wireless communication mechanisms by which information may travel between one computing device and another computing device, network, and the like.

The 3rd party data sources 150, operator platforms 130, and/or the depository platforms 140 may include any of a variety of providers of network transportable digital data. The network transportable digital data can be transported in any of a family of file formats and associated mechanisms usable to enable a host site 110 and a user platform 160 to receive transaction data over the network 115. In one embodiment, the file format can be a text format, a Microsoft™ Excel spreadsheet format, a CSV (Comma Separated Values) format, or the like; however, the various embodiments are not so limited, and other file formats and transport protocols may be used. For example, data formats other than text, Excel, or CSV or formats other than open/standard formats can be supported by various embodiments. Any electronic file format, such as Microsoft™ Access Database Format (MDB), Portable Document Format (PDF), audio (e.g., Motion Picture Experts Group Audio Layer 3—MP3, and the like), video (e.g., MP4, and the like), and any proprietary interchange format defined by specific sites can be supported by the various embodiments described herein.

In a particular embodiment, a user platform 160 with one or more client devices enables a user to access data provided by the commodity transaction validation system 200 via the host 110 and network 115. Client devices of user platform 160 may include virtually any computing device that is configured to send and receive information over a network, such as network 115. Such client devices may include portable devices, such as, cellular telephones, smart phones, camera phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. The client devices may also include other computing devices, such as personal computers, multiprocessor systems, microprocessor-based or programmable consumer electronics, network PC's, and the like. The client devices may also include other processing devices, such as consumer electronic (CE) devices and/or mobile computing devices, which are known to those of ordinary skill in the art. As such, the client devices of user platform 160 may range widely in terms of capabilities and features. A web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript™, EXtensible HTML (xHTML), Compact HTML (CHTML), and the like, to display and/or send digital information. In other embodiments, mobile devices can be configured with applications (apps) with which the functionality described herein can be implemented.

The client devices of user platform 160 may also include at least one client application that is configured to receive transaction and/or control data from another computing device via a wired or wireless network transmission. The client application may include a capability to provide and receive textual data, graphical data, video data, audio data, and the like. Moreover, client devices of user platform 160 may be further configured to communicate and/or receive a message, such as through a Short Message Service (SMS), direct messaging (e.g., Twitter™), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Referring again to FIG. 8, the commodity transaction validation system 200 for an example embodiment is shown to include a commodity transaction validation system database 113. The database 113 can be used to retain a variety of information data sets including, but not limited to, operator information, product or commodity information, depository information, 3^{rd} party information, Track and Trace information, licensing information, transaction information, transaction analytics, and the like. It will be apparent to those of ordinary skill in the art that the commodity transaction validation system database 113 can be locally resident at the host site 110 or remotely located at other server locations or stored in network cloud storage.

Referring again to FIG. 8, host site 110 of an example embodiment is shown to include the commodity transaction validation system 200. In an example embodiment, commodity transaction validation system 200 can include a commodity transaction validation module 111, which includes an operator portal processing module 114, a depository portal processing module 116, and a 3^{rd} party data retrieval module 118. Each of these modules can be implemented as software components executing within an executable environment of commodity transaction validation system 200 with a data processor 112 operating on host site 110 or user platform 160. As described above, the operator portal processing module 114 can be used to manage a user interface through which the operator can input a transaction deposit amount. As also described above, the depository portal processing module 116 can be used to manage a user interface through which a depository representative can review a transaction deposit request and collateral amount submitted by an operator. The 3^{rd} party data retrieval module 118 can be used to manage the transfer, downloading, parsing, and aggregation of information from the 3^{rd} party data sources 150.

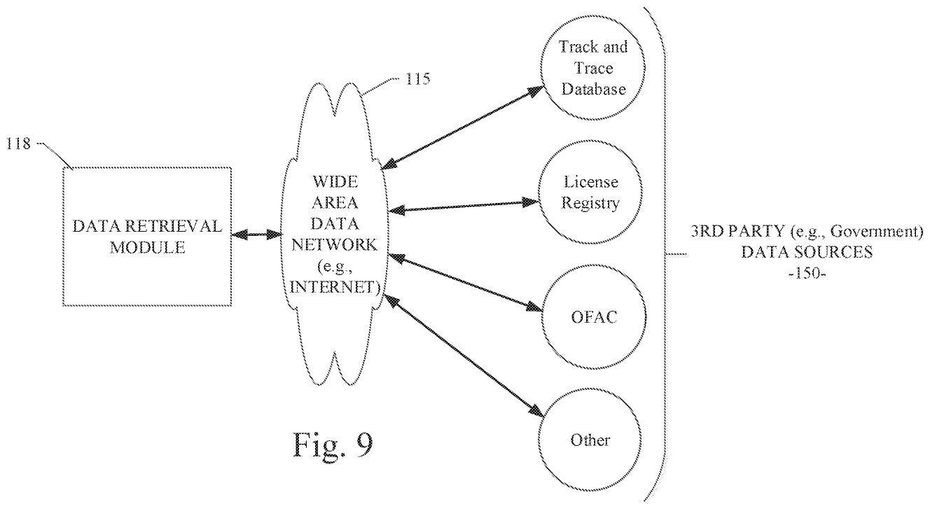

FIG. 9 illustrates another example embodiment of a networked system in which the data retrieval module 118 can interface and retrieve data from a variety of networked 3^{rd} party data sources. The 3^{rd} party data retrieval module 118 can be configured to authenticate and connect with any of a variety of 3^{rd} party information sources, such as a government Track and Trace database, a government or private licensing registry, a portal for the OFAC (Office of Foreign Assets Control), or other government or private data sources.

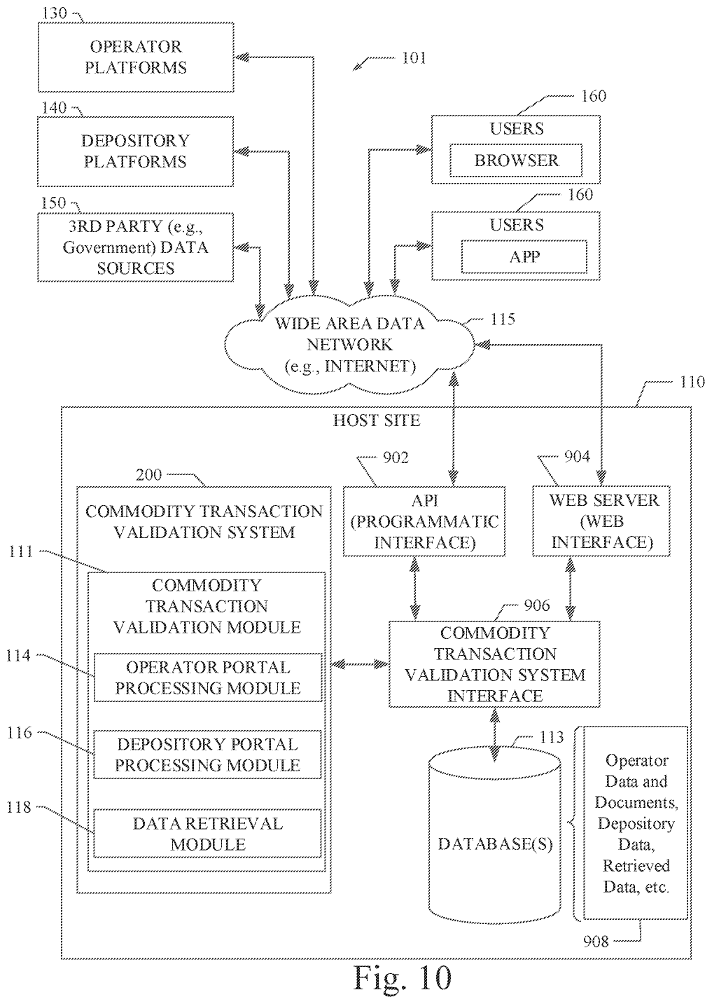

Referring now to FIG. 10, another example embodiment 101 of a networked system in which various embodiments may operate is illustrated. In the embodiment illustrated, the host site 110 is shown to include the commodity transaction validation system 200. The commodity transaction validation system 200 is shown to include a commodity transaction validation module 111, which includes the operator portal processing module 114, the depository portal processing module 116, and the 3^{rd} party data retrieval module 118 as described above. In a particular embodiment, the host site 110 may also include a web server 904, having a web interface with which users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the commodity transaction validation system 200 either directly or via an interface 906. The commodity transaction validation system 200 may be configured to access a data storage device 113 either directly or via the interface 906.

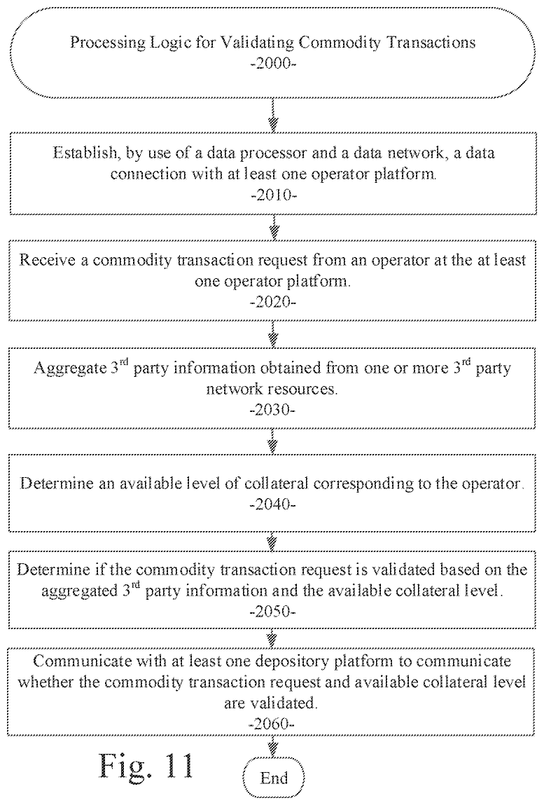

Referring now to FIG. 11, a processing flow diagram illustrates an example embodiment of a method implemented by the commodity transaction validation system 200 as described herein. The method 2000 of an example embodiment includes: establishing, by use of a data processor and a data network, a data connection with at least one operator platform (processing block 2010); receiving a commodity transaction request from an operator at the at least one operator platform (processing block 2020); aggregating 3^{rd} party information obtained from one or more 3^{rd} party network resources (processing block 2030); determining an available level of collateral corresponding to the operator (processing block 2040); determining if the commodity transaction request is validated based on the aggregated 3^{rd} party information and the available collateral level (processing block 2050); and communicating with at least one depository platform to communicate whether the commodity transaction request and available collateral level are validated (processing block 2060).

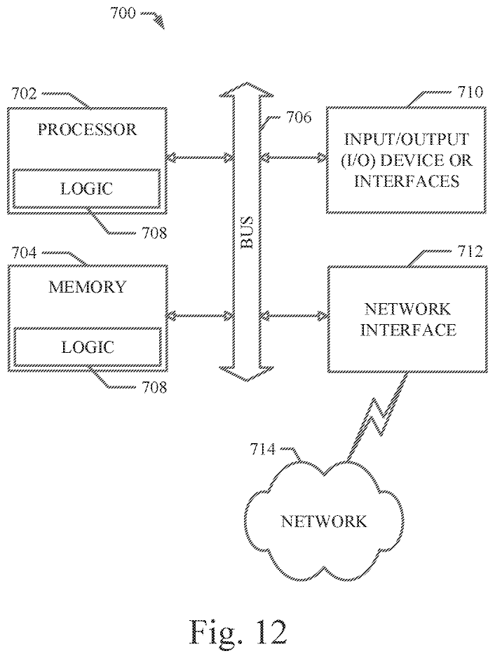

FIG. 12 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a mobile device, a web appliance, a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that stores the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

### Dimension Analysis of an Example Embodiment

In a particular example embodiment, the systems and methods disclosed herein can be used in the automated discovery of illicit operational activity of legitimate cannabis operators. It also balances product sales against the use of financial services in regulated environments. This detection works across multiple dimensions of analysis. Each dimension of analysis in the example embodiment is detailed below.

The first dimension is the use of product sales through track and trace control systems. The sales data from chain of custody track and trace system is used to control the validity of cannabis transactions. The risk control comes from sending and receiving entities agreeing independently that a transaction has occurred for a set of goods at a given price. Once the receipt of goods has been acknowledged by the receiving party, the sale is determined as being legitimate and the funds can be used for banking and financial services transactions. The allocation of product to a precise amount of funds is through partial line-item unit allocations, ex. 0.6 units of 1 pound cannabis flower.

The second methodology is the annualized operational capacity test of cannabis cultivation. This starts by taking in the cultivators' available square footage, growing methodology and growing cycles from state regulatory records. Next, we use statistical regression to determine the accuracy of inputted pricing information against products of similar nature. If the nature is out of statistical average, the pricing is rejected and re-requested from the cannabis entity. These factors produce an average price per square foot of cultivation space. This figure is used to determine an expected crop yield. If the yield value if out of projection, then an alert is triggered on the operator's account for further review. Finally, we check for excessive on hand inventory and excessive product waste.

Typical deviating factors for crop yield under production would be pest infestations, equipment failures, nutritional deficiencies, poor quality and large average market pricing swings. Deviating factors for crop yield over production would be bumper crop, exceptional quality and large average market swings. What is being detected in these scenarios is diversion of product into black market sales or purchase of black market product. At this point, an audit can be performed to check operator claim veracity. If an operator shows a pattern of deviation, it's likely that they are operating in an illicit manner.

The third methodology is distribution pricing analysis. Distributors are defined as licensed cannabis entities responsible for the warehousing and transport of cannabis goods. Distributors collect large volumes of product from a variety of sources and resell/repackage for a markup. We compare distributor average markups on product sales against other distributors. This gives an average product markup value. Deviation from this value triggers an alert. We also check product input to output on an annualized basis. If product is purchased and not sold, or sold without a corresponding purchase, a warning is raised.

The fourth methodology is manufacturing reduction and sales analysis. Reduction is defined as converting raw flower into secondary products, typically waxes and oils. Raw flower has a certificate of authenticity from a certified testing lab. This certificate gives the THC and CBD properties of the raw flower. These figures are input values into a manufactured output of distillate. The higher the values of input, the more distillate that can be made from the input flower. Distillate is sold in liters. Our test is to make sure that an appropriate amount of input flower is legally purchased for the produced end distillate on a quarterly basis. We also compare distillate average sales prices against market averages.

The fifth methodology is analysis of retail purchase and sales activity. We start by verifying the product purchase price of retail inventory purchases against market rates. For micro businesses, we allow in the inclusion of raw flower without a purchase price. The rules from the first methodology apply to onsite cultivating. The inventory figures are checked for average sales markup and corresponding sales. If there is deviation in any of the above described processes, a warning is raised. Next, we check for oversized inventory to determine if there is an abnormal amount of product on hand. Last, we check for excessive product waste against their industry peers.

The final factor in the process is time-based degradation. Based on how product is handled, it can degrade at varying rates. There are industry standard handling methods that produce a best-case scenario degradation process (similar to how alcohol in barrels can evaporate). We apply a slightly sub perfect rate of degradation to get an industry standard degradation rate. This rate is applied to flower during its harvested handling time.

As described herein for various example embodiments, a system and method for validating commodity transactions are disclosed. In the various example embodiments described herein, a computer-implemented tool or software application (app) as part of a commodity transaction validation system is described to automate and improve the collection and verification of commodity transactions between parties in the transaction. In an example embodiment, information and documents are obtained from network sources, analyzed, aggregated, and classified. In various example embodiments described herein, the commodity transaction validation system provides an information and document collection and verification system as it relates to the commodity and finance industry, specifically, to the automatic aggregation of information from network sources as necessary to validate a commodity transaction As such, the various embodiments as described herein are necessarily rooted in computer and network technology and serve to improve these technologies when applied in the manner as presently described and claimed. In particular, the various embodiments described herein improve the use of data network technology in the context of product and commodity purchase, transfer, and financing transactions via electronic means.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method for validating commodity transactions, the method comprising:
establishing, by use of a data processor and a data network, a data connection with at least one operator platform;
receiving, by use of the data processor, a commodity transaction request from an operator at the at least one operator platform;
aggregating, by use of the data processor, third party information obtained from one or more third party network resources;
determining, by use of the data processor, an available level of collateral corresponding to the operator;
determining, by use of the data processor, if the commodity transaction request is validated based on the aggregated third party information and the available collateral level; and
communicating, by use of the data processor, with at least one depository platform to communicate whether the commodity transaction request and available collateral level are validated.

2. The method of claim 1 wherein the one or more third party network resources includes a government track and trace system.

3. The method of claim 1 including receiving collateral from the operator and determining, by use of the data processor, that the received collateral conforms to the available level of collateral corresponding to the operator.

4. The method of claim 1 including interfacing with a legacy accounting software application to track accounts payable from cash accounts.

5. The method of claim 1 including validating a license status of the operator using a government license registry.

6. The method of claim 1 including sending a deposit request to the depository platform.

7. The method of claim 1 wherein the commodity transaction is a sale and purchase of cannabis.

8. The method of claim 1 including determining an accuracy of inputted commodity pricing information based on an annualized operational capacity of an operator and a statistical average of products of similar nature.

9. The method of claim 1 including using a distribution pricing analysis based on product input to output on an annualized basis.

10. The method of claim 1 including verifying a product purchase price of retail inventory purchases against market rates.

11. A commodity transaction validation system for validating commodity transactions, the system comprising:
a data processor having a data network interface with at least one operator platform; and
a commodity transaction validation module, executable by the data processor, the commodity transaction validation module being configured to:
establish, by use of the data processor and the data network interface, a data connection with the at least one operator platform;
receive, by use of the data processor, a commodity transaction request from an operator at the at least one operator platform;
aggregate, by use of the data processor, third party information obtained from one or more third party network resources;
determine, by use of the data processor, an available level of collateral corresponding to the operator;
determine, by use of the data processor, if the commodity transaction request is validated based on the aggregated third party information and the available collateral level; and
communicate, by use of the data processor, with at least one depository platform to communicate whether the commodity transaction request and available collateral level are validated.

12. The system of claim 11 wherein the one or more third party network resources includes a government track and trace system.

13. The system of claim 11 being further configured to receive collateral from the operator and determine, by use of the data processor, that the received collateral conforms to the available level of collateral corresponding to the operator.

14. The system of claim 11 being further configured to interface with a legacy accounting software application to track accounts payable from cash accounts.

15. The system of claim 11 being further configured to validate a license status of the operator using a government license registry.

16. The system of claim 11 being further configured to send a deposit request to the depository platform.

17. The system of claim 11 wherein the commodity transaction is a sale and purchase of cannabis.

18. The system of claim 11 being further configured to determine an accuracy of inputted commodity pricing information based on an annualized operational capacity of an operator and a statistical average of products of similar nature.

19. The system of claim 11 being further configured to use a distribution pricing analysis based on product input to output on an annualized basis.

20. The system of claim 11 being further configured to verify a product purchase price of retail inventory purchases against market rates.
